(19) United States
(12) Patent Application Publication
(10) Pub. No.: US 2013/0262309 A1
(43) Pub. Date: Oct. 3, 2013

(54) Method and System for Secure Mobile Payment

(71) Applicant: Alessandro Gadotti, Hong Kong (HK)

(72) Inventor: Alessandro Gadotti, Hong Kong (HK)

(73) Assignee: MPAYME LTD., Hong Kong (HK)

(21) Appl. No.: 13/602,197

(22) Filed: Sep. 2, 2012

Related U.S. Application Data
(60) Provisional application No. 61/618,848, filed on Apr. 2, 2012.

(51) Int. Cl. G06Q 20/32

(52) U.S. Cl. CPC G06Q 20/3276
USPC 705/44

(57) ABSTRACT

A system and method for conducting secure payment using mobile communication devices, comprising: creating a first user account and a second user account in a central processing server, wherein the first user account creation comprises pairing a first mobile communication device with the first user account; generating, by the central processing server or a second device, a QR code for the second user; optically capturing and decoding the QR code by the first mobile communication device; transmitting the decoded information along with a security PIN provided by the first user to the central processing server upon user verification and confirmation; upon the successful authentication of the first user, transferring funds from the first user account to the second user account; and sending, by the central processing server, to the first user and the second user a notification of the result of the funds transfer.

### CLAIM FOR DOMESTIC PRIORITY

This application claims priority under 35 U.S.C. §119 to the U.S. Provisional Patent Application No. 61/618,848, filed Apr. 2, 2012, the disclosure of which is incorporated herein by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to methods of management and execution of electronic bill payments, electronic purchase payments, fund transfers, and other value exchanges. More specifically, the present invention relates to methods of management and execution of financial transactions using mobile communication devices.

### BACKGROUND

Modern day commerce involves conducting financial transactions through many different channels using a variety of instruments. Payment transfer of physical currency is the most common means when the transacting parties are located away from any banking facility. Other payment methods and systems have appeared over the years. Credit cards, debit cards, Internet online payment services such as PayPal™, and near field communication (NFC) enabled stored value holder devices and systems, such as the Octopus Card widely used in Hong Kong, China, are some of the more prevalent examples. However, none of the existing payment methods and systems has achieved the same level of ubiquity and easiness of use as cash. Each of these payment methods and systems requires its dedicated infrastructure and/or is limited to a few channels. For instance, credit card payments require the merchants or the payees to be equipped with card readers and fixed communication networks connecting the readers to the clearance centers.

Another shortcoming of existing payment methods and systems is that person-to-person transactions are either unfeasible or highly inconvenient. Take credits cards, debit cards, and other stored value cards for instance. Although it is possible to mass-produce personal card readers with the current technology, the need for dedicated infrastructures, which are yet to be built out on a scale beyond the city level, is an impediment to their general availability and adoption. Moreover, the inconvenience of carrying an extra card reader, security concerns, such as authentication of card ownership, and potential high transaction cost to both payers and payees are some of the unresolved issues that cast doubts on their wide usages.

### SUMMARY

It is an objective of the presently claimed invention to provide a mobile payment method and system that can substitute the use of physical currency with the same level of ubiquity and ease of use. It is a further objective of the presently claimed invention to provide a mobile payment method and system that can leverage existing mobile communication devices and communication infrastructures, and does not require a dedicated infrastructure of hardware or network. It is still a further objective of the presently claimed invention to provide a mobile payment method and system having a higher level of security than existing payment methods and systems.

In accordance with various embodiments, the presently claimed invention comprises a central processing server accessible through a first communication network, such as the Internet; a plurality of users including individual users and business users; mobile communication devices and client computing devices that can access the central processing server through the first communication network; and financial institutions, exchanges, and clearance centers connected to the central processing server through a second communication network, which can be the same as the first communication network.

In accordance with various embodiments, the functionalities of the central processing server comprises user account management for managing user accounts and authenticating users, wherein the user accounts contain user identification and banking information, and are stored securely in a data repository. The central processing server provides an electronic repository of credits or monetary units for each user account (eWallet). The central processing server also provides transaction clearance functionality for processing payments and financial transactions for the users associated with the user accounts. The central processing server has backend network connections and machine-to-machine integration mechanisms, such as application program interfaces (APIs), to connect and integrate with financial institutions, financial exchanges, and clearance centers, facilitating the processing of payments and financial transactions for and between the users associated with the user accounts.

In accordance with various embodiments, the central processing server includes a plurality of user interfaces for user interaction using various types of computing devices and mobile communication devices running web browser applications. In addition, the central processing server also includes secure mobile payment server backend APIs for machine-to-machine integration enabling specially-developed applications running in computing devices or mobile communication devices to communicate with the central processing server. These user interfaces and secure mobile payment server backend APIs facilitate the functionalities including, but are not limited to, user account management and online shopping by users, system administration by administrators, online shopping inventory, payment, and fulfillment management by business users.

In accordance with various embodiments, a user account in the central processing server is associated with the user's mobile communication device to facilitate financial transaction processing. The central processing server also allows the user to define a security personal identification number (PIN) and associate it with his/her user account.

In accordance with various embodiments, the user's mobile communication device is equipped with a display screen for displaying a computer-generated barcode and a camera or scanner for optically capturing the image of the computer-generated barcode.

In accordance with various embodiments, the computer-generated barcode is a matrix or two-dimensional barcode such as a Quick Response (QR) code. The barcode contains encoded data on the identity of the barcode originating user, security data, and optionally a base currency, a payment money amount, reference information on the specific transaction, point of sale, or the product or service associating with the barcode, wherein the referenced information is prior-defined and preserved in the data reposition in the central processing server. The barcode can represent a utility bill, a price quotation, a purchase order of goods, an authorization of fund transfer, a financial transaction request or approval, or a security access keycode. The barcode can be printed and displayed on physical merchandise, on printed media advertising a product such as a product catalog, a poster, or a magazine, an electronic publication such as a web site, or on a paper invoice. The barcode can also be embedded in an electronic message and be displayed by any device capable of receiving and displaying the electronic message. The electronic message can be an electronic mail, an Internet instant message, or a Short Message Service (SMS) telecommunication message. The barcode can also be displayed by a mobile communication device running the secure mobile payment mobile application.

In accordance with various embodiments, the user's mobile communication device is configured to process the captured barcode image and initiate the payment or transaction process. In accordance with various embodiments, the mobile communication device configuration for processing the barcode and transaction is accomplished by application software and/or firmware specifically designed for the mobile communication device (secure mobile payment mobile application).

The payment or transaction process comprises optically capturing a barcode image by the initiating user's mobile communication device running the secure mobile payment mobile application; and decoding, by secure mobile payment mobile application, the barcode, and displaying the decoded information to the initiating user for verification. Optionally, the initiating user is allowed to make modification to the decoded information and/or append new data, such as a payment amount, to be transmitted to the central processing server by the secure mobile payment mobile application. The payment or transaction process further comprises prompting and receiving from the initiating user, by the secure mobile payment mobile application, his/her security PIN. The security PIN is then transmitted to the central processing server along with the decoded information, the modified data, appended new data, and identification data about the mobile communication device.

The central processing server receives the information and verifies the authenticity of the information received and the initiating user using the initiating user's security PIN, the identification data about the mobile communication device, and data in initiating user account preserved in the central processing server. If the authenticity of the information received and the initiating user's identity are positively verified, the central processing server executes the transaction transferring funds from the eWallet of the payer user account to the eWallet of the payee or barcode originator user account.

The central processing server then sends the execution result of the transaction to both the initiating user and the barcode originator by electronic mail, Internet instant message, SMS telecommunication message, communication message for the secure mobile payment mobile application, or machine-to-machine communication via its secure mobile payment server backend APIs. The transaction execution results and history logs are also shown in a user interface, such as a web site accessible and readable by a computing device or a mobile communication device running a web browser application, or any application software or firmware designed specifically to access and display web contents.

Besides mobile payments, in accordance with another embodiment, the presently claimed invention can also provide a novel way to conduct lodging room reservation and check-in. A barcode is generated for an assigned hotel room reserved by a user. When the user arrives at the hotel, he/she can proceed directly to the assigned hotel room. Using a mobile communication device that has been paired with his/her user account, he/she optically captures the barcode presented at the hotel room door and enters his/her security PIN in the secure mobile payment mobile application running in the mobile communication device. The barcode information and the security PIN are sent to the central processing server for authentication and verification against a prior-defined and preserved room reservation record with the hotel reservation system. Upon a positive authentication and verification, the user is checked in and the hotel room door is unlocked for entry.

### BRIEF DESCRIPTION OF THE DRAWINGS

Embodiments of the invention are described in more detail hereinafter with reference to the drawings, in which

FIG. 1 shows a block diagram illustrating an exemplary embodiment of the presently claimed secure mobile payment system;

FIG. 2 depicts a use case diagram illustrating an embodiment of a process of making payment in accordance to the presently claimed invention;

FIG. 3 depicts a use case diagram illustrating an embodiment of a process of requesting a payment from another in accordance to the presently claimed invention;

FIG. 4a depicts a use case diagram illustrating an embodiment of a process of paying for merchandise at retail stores in accordance to the presently claimed invention;

FIG. 4b depicts a use case diagram illustrating another embodiment of a process of paying for merchandise at retail stores in accordance to the presently claimed invention;

FIG. 5 depicts a use case diagram illustrating an embodiment of a process of paying utility bills in accordance to the presently claimed invention;

FIG. 6 depicts a use case diagram illustrating an embodiment of a process of virtual shopping in accordance to the presently claimed invention; and

FIG. 7 depicts a use case diagram illustrating an embodiment of a process of conducting lodging room reservation and check-in in accordance to the presently claimed invention.

### DETAILED DESCRIPTION

In the following description, methods and systems of secure mobile payment and the like are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

System:

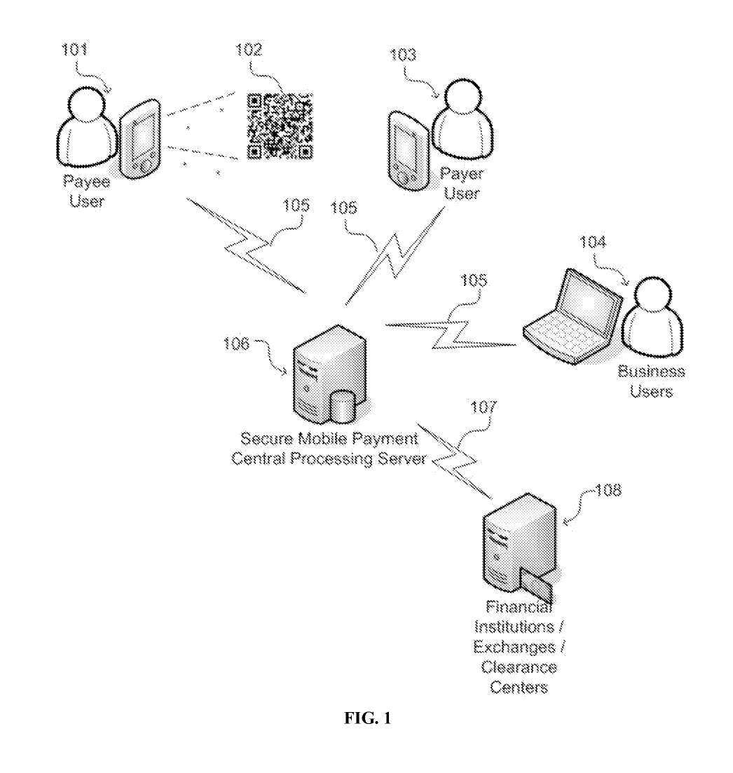

Referring to FIG. 1. In accordance with various embodiments the presently claimed invention comprises a central processing server 106 accessible through a first communication network 105 such as the Internet; a plurality of users including individual users 101 and 103, and business users 104; mobile communication devices and computing devices that can access the central processing server through the first communication network 105; and financial institutions, exchanges, and clearance centers 108 connected to the central processing server through a second communication network 107, which can be the same as the first communication. Exemplary embodiments of mobile communication devices include, but are not limited to, mobile telephones, mobile telephones with personal computer like capability (commonly referred to as “smartphones”), electronic personal digital assistants (PDAs), portable computers with wired or wireless wide-area-network and/or telecommunication capability such as tablet personal computers and “netbook” personal computers. Exemplary embodiments of computing devices include, but are not limited to, personal computers, electronic point-of-sale cash registry machines, and electronic kiosks.

In accordance with various embodiments, the user's mobile communication device is equipped with a display screen for displaying a computer-generated barcode 102 and a camera or scanner for optically capturing the image of the computer-generated barcode.

In accordance with various embodiments, the computer-generated barcode is a matrix or two-dimensional barcode such as a Quick Response (QR) code. The barcode contains encoded data on the identity of the barcode originating user, a base currency, and security data; and optionally a base currency, a payment money amount, information on the specific transaction, point of sale, and the product or service associating with the barcode. The barcode can represent a utility bill, a price quotation, a purchase order of goods, an authorization of fund transfer, a financial transaction request or approval, or a security access keycode. The barcode can be printed and displayed on physical merchandise, on printed media advertising a product such as a product catalog, a poster, or a magazine, an electronic publication such as a web site, or on a paper invoice. The barcode can also be embedded in an electronic message and be displayed by any device capable of receiving and displaying the electronic message. The electronic message can be an electronic mail, an Internet instant message, or a Short Message Service (SMS) telecommunication message. The barcode can also be displayed by a mobile communication device running the secure mobile payment mobile application.

In accordance with various embodiments, the user's mobile communication device is configured to process the captured barcode image and initiate the payment or transaction process. In accordance with various embodiments, the mobile communication device configuration for processing the barcode and transaction is accomplished by application software and/or firmware specifically designed for the mobile communication device (secure mobile payment mobile application).

In accordance with various embodiments, the functionalities of the central processing server comprise a user account management functionality for managing user accounts and authenticating users, wherein the user accounts contain user identification and banking information, and are stored securely in a data repository. The central processing server includes a virtual repository of monetary units (eWallet) for each user account enabling the monetary payments and fund transfers from one user account to another. The eWallet can also be debited and credited to and from an external funding source such as the user's credit card or bank account.

The central processing server includes a first group of user interfaces for individual users accessible by computing devices and mobile communication devices through a communication network, such as the Internet, a telecommunication network, and any network supporting the TCP/IP protocol; and a second group of user interfaces for business users accessible by computing devices and mobile communication devices through the communication network. Both groups of user interfaces include interactive transactional web sites that can be displayed in web browser applications running in computing devices and mobile communication devices, and user interfaces that are specifically designed as mobile applications running in mobile communication devices. One exemplary embodiment of such user interface is a mobile application (App) running on the iOS operating system developed by Apple Inc. Another exemplary embodiment of such user interface is a mobile application (App) running on the Android operating system developed by Google Inc. The central processing server also provides a third group of user interfaces for system administrator accessible by computing devices and through the communication network.

In addition to the groups of user interfaces, the central processing server also includes secure mobile payment server backend APIs for machine-to-machine integration, enabling specially-developed applications running in computing devices or mobile communication devices to communicate with the central processing server. In accordance to various embodiments, the machine-to-machine data interchanges via the secure mobile payment server backend APIs supports industry standards including, but are limited to, XML and JSON.

The central processing server further comprises transaction clearance functionalities for processing payments and financial transactions for the users associated with the user accounts. The central processing server has backend network connections and machine-to-machine integration mechanisms, such as the secure mobile payment server backend APIs, to connect and integrate with financial institutions, financial exchanges, and clearance centers, facilitating the processing of payments and financial transactions for and between the users associated with the user accounts.

Individual User Account Setup:

In accordance to various embodiments, the method of secure mobile payment comprises an individual user account setup process, wherein the individual user account setup process comprises the steps of user registration, user validation, user profile management, funding source management, and device pairing as listed below:

User Registration:
1. A new individual user accesses the central processing server user interface using a client computing device with a browser software application or a mobile communication device configured to be able to access the central processing server user interface.
2. The new individual user selects create user account action in the central processing server user interface, provides his/her personal information including at least his/her first name, last name, and email address, a mobile phone number including the country code, and provides a password for subsequently signing into the central processing server.
3. The new individual user is also asked to select from a list of security questions, such as “Where did you travel on your honeymoon?” and “What is the name of your first pet?”, and provide the answer to the chosen security question. Lastly, the new individual user is asked to provide the answer to a qualifying question, such as a portion of a government issued identification number.

User Validation:
4. The central processing server sends a validation email to the email address provided by the new individual user.
5. The newly created user account is validated by the new individual user receiving and reading the validation email, and accessing a validation web hyperlink, which bears the new individual user's personal identification data within, in the validation email.
6. The access action of the validation web hyperlink sends the new individual user's personal identification data to the central processing server; and upon the receipt of this data, the validation of the newly created user account is completed, and the new individual user is notified as such.

User Profile Management:
7. After the newly created user account is validated, the new individual user can access his/her user account by accessing the central processing server user interface and signing in using his/her email address, mobile phone number, and password.
8. After signing into his/her user account, the new individual user can enter and modify his/her user profile information including, but is not limited to, name, email address, residence address, business address, delivery address, and mobile phone number for being saved and associated with his/her user account.

Funding Source Management:
9. Within the user account signed-in session, the new individual user can add, modify, and remove one or more funding source to associate with his/her user account. The funding source is for crediting to (recharging) and debiting from (withdrawing) the virtual repository of monetary units of his/her user account. For adding a funding source, the new individual user can select a credit card, debit card, bank account, or other funding source type, enter the card number or account number, the card or account holder's name and billing address, applicable expiration date and verification code.
10. The central processing server creates an unverified funding source with information entered by the new individual user.
11. Only a verified funding source can be used to recharge and withdraw the eWallet of the user account. The new individual user can initiate the verification of the newly added funding source within the user account signed-in session.
12. For credit card type funding source, a debit of small amount is made against the credit card with a reference identifier associated with the transaction, which is shown on the credit card account statement. The debited amount is credited to the eWallet of the new individual user's user account. The funding source verification is completed upon the new individual user retrieving the reference identifier and entering it in the central processing server user interface during a user account signed-in session.
13. For bank account type funding source, two debits of two different amounts are made against the bank accounts, which can be shown on the bank account statement. The debited amounts are credited to the eWallet of the new individual user's user account. The funding source verification is completed upon the new individual user being notified of the two debits and entering them central processing server user interface during a user account signed-in session.
14. Within the user account signed-in session, the new individual user can indicate to the central processing server to link the eWallet to her/her user account with one or more verified funding sources for transferring funds between the eWallet and the linked verified funding sources.

Device Pairing:
15. A mobile communication device equipped with an image scanner or camera must be paired with the new individual user's user account. Only one mobile communication device can be paired with a user account at any one time. If a user account is already paired with a mobile communication device, it must be unpaired before another mobile communication device is paired with the user account.
16. The new individual user configures his/her mobile communication device to be able to access the central processing server user interface. In one exemplary embodiment, the new individual user uses his/her mobile communication device to access a mobile application store, find, download, and install the secure mobile payment mobile application, which is specifically designed to interact with the central processing server, in his/her mobile communication device. By launching and interacting with the secure mobile payment mobile application running in his/her mobile communication device, the new individual user can access the central processing server to initiate the pairing process.
17. Using the secure mobile payment mobile application running in his/her mobile communication device, the new individual user signs in to his/her user account using his/her email, mobile phone number, and password that are registered in a prior user registration. The information is sent to the central processing server for authentication.
18. The central processing server authenticates the new individual user. Upon a positive authentication, the central process server identifies that the mobile communication device is not yet paired with the user account, replies with the previously chosen security question and qualifying question to the mobile communication device running the secure mobile payment mobile application.
19. The new individual user is prompted to enter an answer to the security question and an answer to the qualifying question; and the answers are sent to the central processing server.
20. The central processing server verifies the security answer and the qualifying answer. Upon a positive verification, the central processing server sends the mobile communication device a SMS message communication containing an activation code.
21. Upon receiving the SMS message communication and the activation code contained within, the new individual user enters the activation code and a user-defined security PIN in the secure mobile payment mobile application. In one embodiment, the security PIN can be a 4, 5, or 6-digit number combination.
22. The activation code and the security PIN are sent to the central processing server for verification and storage, completing the device pairing process.

Merchant User Account Setup:

In accordance to various embodiments, the method of secure mobile payment comprises a merchant user account setup process, wherein the merchant user account setup process comprises the steps of user registration, user validation, user profile management, funding source management, device pairing, and user account activation as in the individual user account setup process as described above. The merchant user account setup process, however, further comprises the steps of creating delegate users, delegate user validation, and delegate user device pairing.

Creating Delegate Users:
1. After the user validation step is complete, the new merchant user can access his/her user account by accessing the central processing server user interface and signing in using his/her email address, mobile phone number, and password. Using the central processing server user interface, the new merchant user provides the identity information, email addresses, mobile phone numbers, and passwords of one or more delegate users. The new merchant user can specify the level of authorization and access for each delegate user; wherein the level of authorization is selected from a selection comprising view the merchant user account information only, administer the merchant user account, make payments, and request payments from others. The new merchant user can specify limits on spending amounts for each delegate user.

Delegate User Validation:
2. After the new merchant user created the one or more delegate users, the central processing server sends a validation email to each of the delegate user email addresses provided by the new merchant user. The remaining delegate user validation steps are substantially the same as the user validation steps for individual user.

Delegate User Device Pairing:
3. If a delegate user is assigned a level of authorization of at least make payments or request payments from others, the delegate user can pair his/her mobile communication device with the merchant user account. The delegate user device pairing steps are substantially the same as device pairing steps for individual user.

Make Payments:

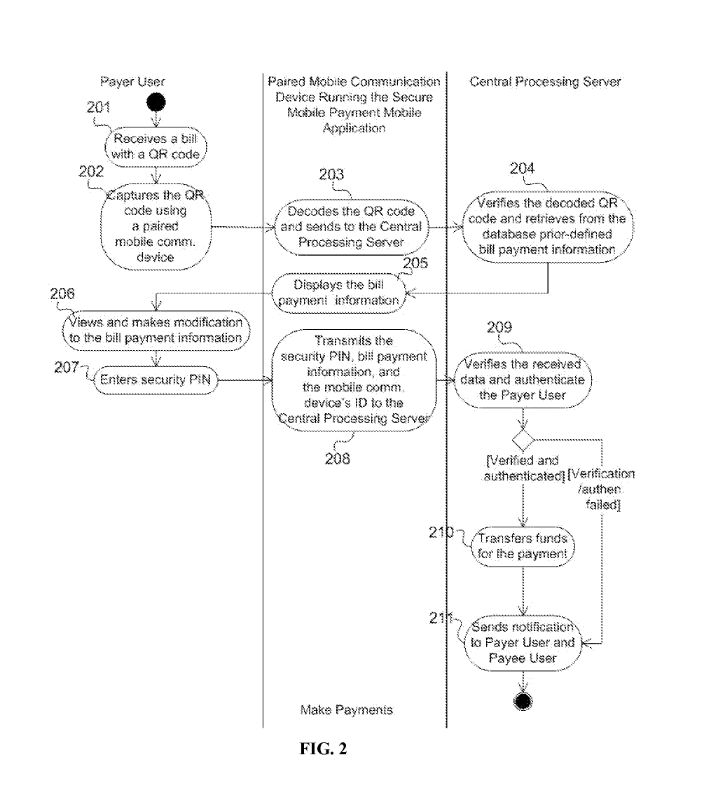

Referring to FIG. 2. In accordance to various embodiments, the method of secure mobile payment comprises a payment process comprising the following steps:
1. (201) A payer user receives a presentment of payment request, such as a bill or a price tag on merchandise, with a QR code; wherein the QR code is generated by the central processing server or by the payee user using his/her mobile communication device running the secure mobile payment mobile application; and wherein the presentment of payment request can be a printed media, an electronic message such as an electronic mail, an Internet instant message, or a SMS telecommunication message being displayed electronically, or the QR code being displayed by a mobile communication device running the secure mobile payment mobile application.
2. (202) The payer user uses a mobile communication device equipped with a scanner or a camera running the secure mobile payment mobile application to optically capture the QR code; wherein the mobile communication device has already been paired with the payer user's user account.
3. (203) The secure mobile payment mobile application decodes the QR code and sends the decoded information to the central processing server.
4. (204) The central processing server verifies the decoded QR code information received. Upon a positive verification, the central process server retrieves from its data repository the bill payment information using a reference data in the decoded QR code information received. The bill payment information can include a money amount, description of the specific transaction, point of sale, and the product or service.
5. (205) The bill payment information is sent back to the mobile communication device and be displayed to the payer user in the secure mobile payment mobile application.
6. (206) Using the secure mobile payment mobile application, the payer user can make modification to the bill payment information including the money amount.
7. Using the secure mobile payment mobile application, the payer user can optionally provide additional information such as whether the payment is recurring, and if so, the recurrence frequency, payment settlement dates, and effective time periods. The payer user can also provide an address and time for the delivery.
8. (207) The secure mobile payment mobile application prompts the payer user for entering his/her security PIN.
9. With the security PIN entered, the payer user indicates in the secure mobile payment mobile application to complete the payment.
10. (208) The secure mobile payment mobile application transmits the payer user's security PIN to the central processing server along with the bill payment information, the modified data, appended new data, and identification data about the mobile communication device.
11. (209) The central processing server receives the information and verifies the authenticity of the information received and the payer user using the payer user supplied security PIN, the identification data about the mobile communication device, and data in payer user account preserved in the central processing server. (210) If the authenticity of the information received and the payer user's identity are positively verified, the central processing server executes the transaction by transferring funds from the eWallet of the payer user account to the eWallet of the payee user account.
12. (211) The central processing server then sends the execution result of the transaction to both the payer user and the payee user by electronic mail, Internet instant message, SMS telecommunication message, communication message for the secure mobile payment mobile application, or communication via the secure mobile payment server backend APIs. The transaction execution results and history logs are also shown in a web site accessible and readable by a computing device or a mobile communication device running a web browser application, or any application software or firmware designed specifically to access and display web contents.

Request Payments from Others:

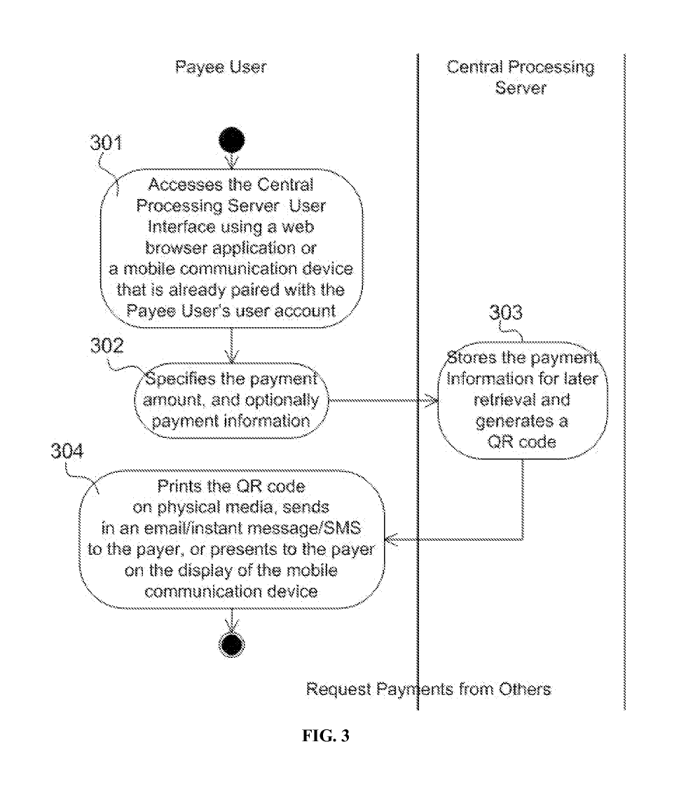

Referring to FIG. 3. In accordance to various embodiments, the method of secure mobile payment comprises a process of a user of the secure mobile payment method requesting payments from one or more other users comprising the following steps:
1. (301) A payee user accesses the central processing server user interface using a computing device or mobile communication device running a web browser application and signs in with his/her email address, mobile phone number, and password; or a mobile communication device, that has already been paired with the payee user's user account, running the secure mobile payment mobile application.
2. If the web browser application is used, (302) the payee user indicates in the central processing server user interface to generate a QR code with a money amount and optionally the payment information including the payer's name, description of the specific transaction, point of sale, and the product or service. The payment information is stored in the data repository of the central processing server for later retrieval by using the QR code. (303) The QR code is generated by the central processing server and transmitted to the payee user's web browser application for (304) onscreen display, print out on physical media, or attachment in an electronic mail or message to the payer user. When the payer user receives and views the QR code, the payer user can capture the image of the QR code using his/her mobile communication device to initiate the payment process.
3. If the secure mobile payment mobile application is used, (303) the QR code is generated by the central processing server and transmitted to the payee user's mobile communication device for (304) onscreen display to be shown to the payer user, such that the payer user can capture the image of the QR code using his/her mobile communication device to initiate the payment process.

Paying for Merchandise at Retail Stores:

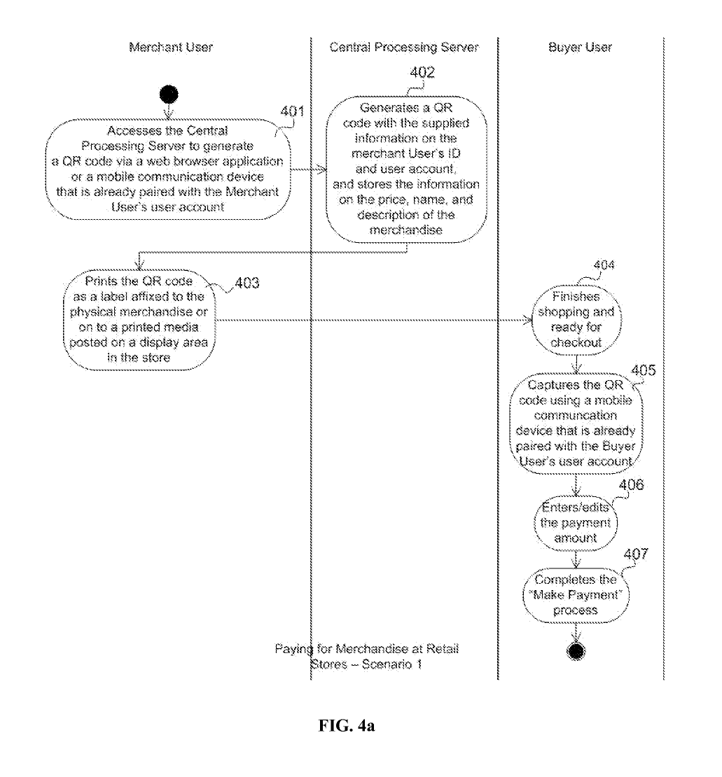

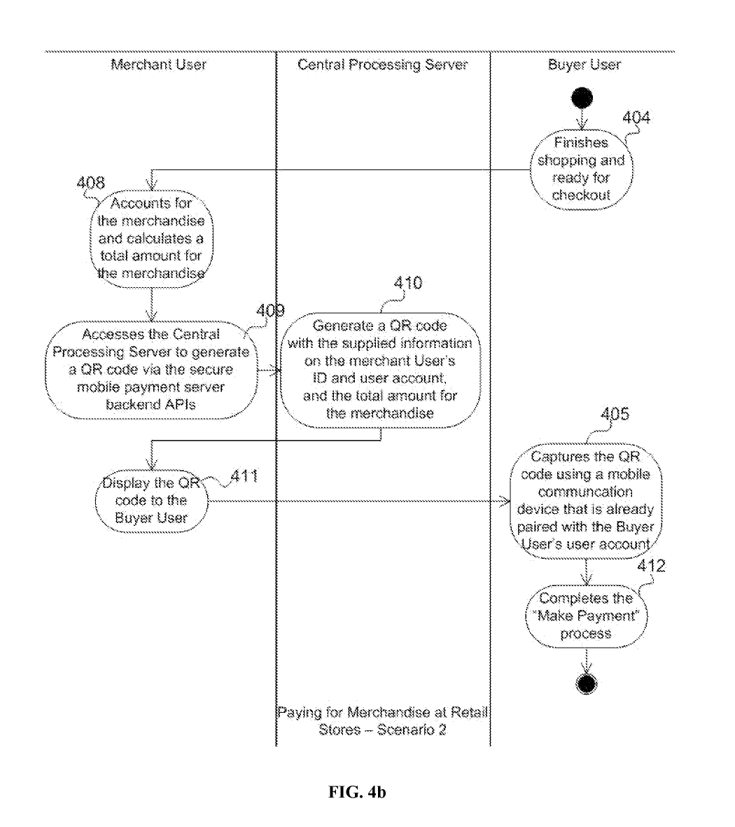

Referring to FIG. 4a and FIG. 4b. In accordance to various embodiments, the method of secure mobile payment comprises a process of a customer user paying for merchandise at retail stores comprising the following steps:
1. (401) A QR code is generated by a merchant user using a client computing device or mobile communication device running a web browser application accessing the central processing server; or a mobile communication device, that has already been paired with the merchant user's user account, running the secure mobile payment mobile application.
2. Alternatively, the merchant user can employ a computing device or processing server specially configured to interface with the central processing server via the secure mobile payment server backend APIs in the generation of the QR code.
3. (402) The QR code can be generated with at least information on the identity of the merchant user. Included in the generation of the QR code is reference data that can be used to refer to the merchant user-defined merchandise information preserved in the central processing server data repository. The merchandise information can include the product name, product description, and the money amount for the sales price plus applicable tax per unit of the merchandise.
4. Alternatively, the information on the merchandise can be pre-defined by the merchant user using the central processing server user interfaces or the secure mobile payment server backend APIs and be preserved in the central processing server data repository. One or more QR codes can then be generated rapidly by recalling the preserved information on the merchandise.
5. (403) The QR code can be printed out as a label affixed to the goods items or on a printed media, displayed on a monitor screen, or posted on a display area preferably at a checkout counter, such that a customer user, (404) when paying for the merchandise, (405) can optically capture the image of the QR code using his/her mobile communication device running the secure mobile payment mobile application and initiate the payment process.
6. Alternatively, (409) the merchant user can employ a computing device specially configured to interface with the central processing server via the secure mobile payment server backend APIs and (410) generate the QR code dynamically with the exact money amount to be paid by the customer for his/her purchases at the checkout counter, (411) wherein the dynamically generated QR code can be printed out on paper or displayed electronically for the customer user can optically capture the image of the QR code using his/her mobile communication device running the secure mobile payment mobile application and initiate the payment process.
7. Upon the completion of the payment process, both merchant user and the customer user receive a transaction completion notification.

Paying for Utility Bills:

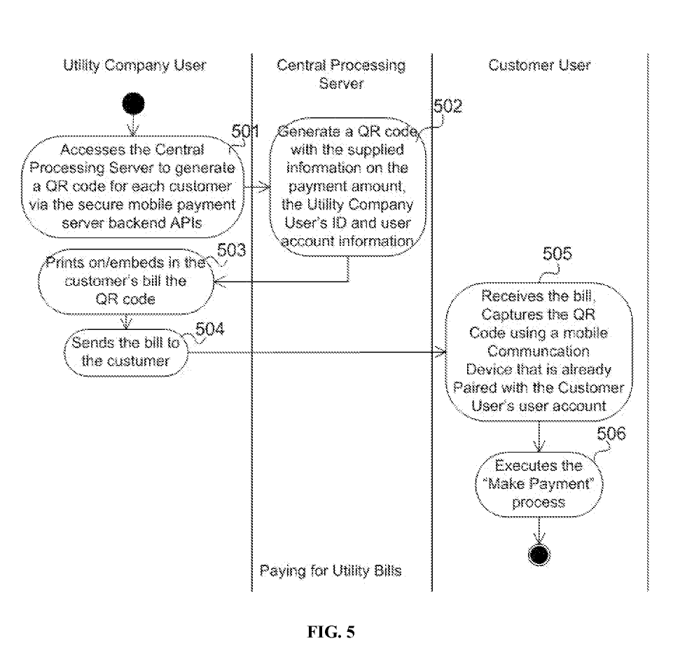

Referring to FIG. 5. In accordance to various embodiments, the method of secure mobile payment comprises a process of a customer user paying for utility bill comprising the following steps:
1. (501 and 502) QR codes are generated by a utility company user using a computing device or processing server specially configured to interface with the central processing server via the secure mobile payment server backend APIs.
2. One QR code is generated for each customer of the utility company with information on the identification and user account of the utility company user and a money amount for charges incurred for the service period for the customer of the utility company.
3. Optionally, the utility company user can specify one or more interactive questions, such as “Do you want to switch to receiving e-bill and stop all paper bills in the future?”, to be presented during the utility company customer user's payment process.
4. (503) The QR code is printed on a utility bill for the customer of the utility company and is sent physically or electronically to the customer.
5. If the customer of the utility company receiving the utility bill has a secure mobile payment user account, (505) the user can optically capture the image of the QR code on the utility bill using his/her mobile communication device running the secure mobile payment mobile application and initiate the payment process.
6. If the utility company user has specified one or more interactive questions to be presented during the payment process, the secure mobile payment mobile application presents the interactive questions and prompts for the answers from the utility company customer in the payment process step 206. The answers are to be sent back to the central processing server then relayed back to the utility company user.

In accordance to various embodiments, the method of secure mobile payment comprises a process of a customer user paying for telephone, cable television, any recurring service or subscription bill which is substantially similar to the process of paying for utility bill as described above.

Virtual Shopping:

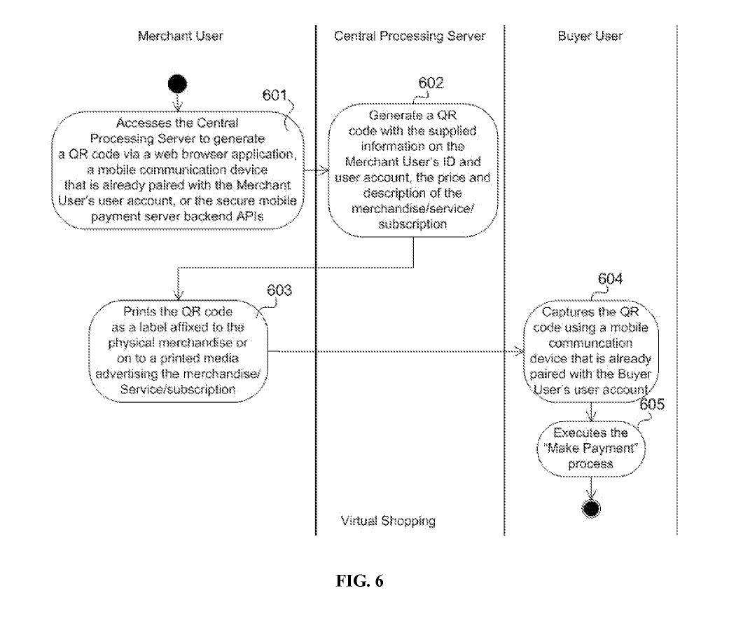

Referring to FIG. 6. In accordance to various embodiments, the method of secure mobile payment comprises a process of a user conducting virtual shopping comprising the following steps:
1. (601) A QR code is generated by a merchant user using a client computing device or mobile communication device running a web browser application accessing the central processing server; or a mobile communication device, that has already been paired with the merchant user's user account, running the secure mobile payment mobile application.
2. Alternatively, the merchant user can employ a computing device or processing server specially configured to interface with the central processing server via the secure mobile payment server backend APIs in the generation of the QR code.
3. (602) The QR code is generated with information on the identity of the merchant user, a money amount for the sales price plus applicable tax of the merchandise, service, or subscription item(s).
4. (603) The QR code can be printed out as a label affixed to the physical merchandise or printed directly on to printed media advertising the merchandise, service, or subscription such as a product catalog, a poster, or a magazine, or in an electronic publication such as a web page. The QR code can also be embedded in an electronic message and be displayed by any device capable of receiving and displaying the electronic message. The electronic message can be an electronic mail, an Internet instant message, or a Short Message Service (SMS) telecommunication message sent to targeted buyers.
5. (604) An interested buyer user can purchase the desired merchandise, service, or subscription by optically capturing the image of the QR code using his/her mobile communication device running the secure mobile payment mobile application and initiating the payment process.
6. The buyer user can provides a delivery address or other data along w/ the confirmation of payment in the payment process step 206. The answers are to be sent back to the central processing server then relayed back to the merchant user.

Lodging Room Reservation and Check-In:

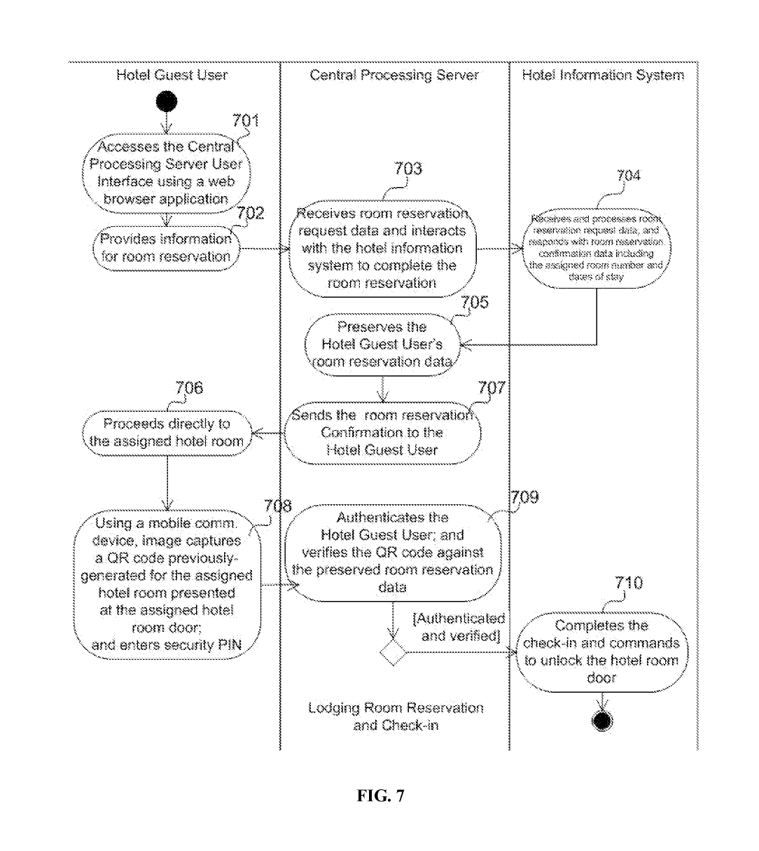

Referring to FIG. 7. In accordance to various embodiments, the method of secure mobile payment comprises a process of a user conducting lodging room reservation and check-in comprising the following steps:
1. (701) A hotel guest user accesses the central processing server user interface using a computing device or a mobile communication device running a web browser application and signs in with his/her email address, mobile phone number, and password.
2. (702) The hotel guest user indicates in the central processing server user interface to make a lodging reservation and provides the lodging details. (703 and 704) The central processing server interacts with the hotel information system with data exchanges, such as dates of stay, accommodation type and assignment, to facilitate the reservation via the secure mobile payment server backend APIs. Upon the completion of the transaction, (705) the central processing server preserves the reservation information in the data repository. (707) The reservation confirmation information are sent to the customer user's web browser application for onscreen display or print out on physical media, or to the customer user in an electronic mail, Internet instant message, SMS telecommunication message, or communication message for the secure mobile payment mobile application running in the hotel guest user's mobile communication device.
3. Alternatively, the hotel guest user can access an online or offline facility operates by the hotel for making the room reservation. The hotel's online or offline facility interacts with the central processing server via the secure mobile payment server backend APIs and sends the reservation information to central processing server.
4. When the hotel guest user arrives at the hotel, (706) he/she can proceed directly to the room assigned. (708) Using a mobile communication device that has been paired with his/her user account, the hotel guest user optically captures a QR code presented at the room door and enters his/her security PIN in the secure mobile payment mobile application running in the mobile communication device, wherein the QR is previously generated by the hotel specifically for the assigned room. (709) The QR code is processed and the processed data along with the security PIN are sent to the central processing server for authentication and verification against the prior-preserved reservation information. (710) Upon positive authentication and verification, the room door is unlocked. The central processing server also interacts with the hotel information system with data exchanges to complete the check-in procedure including, if necessary, the guest user's identification or travel documents preserved in the central processing server to comply with local laws and regulations.

The embodiments disclosed herein may be implemented using general purpose or specialized computing devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A method for conducting secure payment using mobile communication devices, comprising:
creating a first user account for a first user in a central processing server,
wherein the first user account creation comprises pairing a first mobile communication device with the first user account,
wherein the first mobile communication device being equipped with an optical scanner or camera and configured to communicate with the central processing server, and
wherein the first user account creation further comprises creating a first virtual repository of monetary units associating with the first user account;
creating a second user account for a second user in a central processing server,
wherein the second user account creation comprises creating a second virtual repository of monetary units associating with the second user account;
generating, by the central processing server or a second device, a barcode, wherein the second device being configured to communicate with the central processing server;
presenting the barcode to the first user;
optically capturing the barcode by the first mobile communication device;
processing, by the first mobile communication device, the barcode, decoding information contained in the barcode, and displaying the decoded information to the first user for user verification;
transmitting, by the first mobile communication device, the decoded information to the central processing server upon user confirmation;
transferring, by the central processing server, monetary units between the first virtual repository of monetary units and the second virtual repository of monetary units; and
sending, by the central processing server, to the first user and the second user a notification of result of the transfer;
wherein the barcode is generated for the second user and comprises encoded data of identity of the second user and security data.

2. The method of claim 1,
wherein the pairing of a first mobile communication device with the first user account comprises the first user defining a security personal identification number (PIN) to be preserved in the central processing server; and
wherein the user confirmation of the decoded information comprises the first user providing the security PIN to be transmitted by the first mobile communication device to the central processing server for authentication.

3. The method of claim 1, wherein the barcode further comprises encoded data of a payment money amount, and a base currency.

4. The method of claim 1, wherein the second device being a mobile communication device that is paired with the second user account, and is configured to display the barcode.

5. The method of claim 1, wherein the central processing server is configured to provide user interfaces that are accessible and displayable by web browser applications running in computing devices or mobile communication devices.

6. The method of claim 1, wherein the central processing server is configured to provide secure mobile payment server backend application program interfaces (APIs) enabling specially-developed applications running in computing devices or mobile communication devices to communicate with the central processing server.

7. The method of claim 5, wherein the second device being a computing device configured to run a web browser application accessing and displaying the user interfaces provided by the central processing server.

8. The method of claim 6, wherein the second device being a computing device configured to run a specially-developed application communicating with the central processing server via the secure mobile payment server backend APIs.

9. The method of claim 1, wherein the barcode being a Quick Response (QR) code.

10. A system for secure payment using mobile communication devices, comprising:
a central processing configured to:
create a first user account for a first user, wherein the first user account creation comprises pairing a first mobile communication device with the first user account, and creating a first virtual repository of monetary units associating with the first user account;
create a second user account for a second user, wherein the second user account creation comprises creating a second virtual repository of monetary units associating with the second user account; and
generate a barcode;
the first mobile communication device equipped with an optical scanner or camera and configured to:
communicate with the central processing server;
optically capture the barcode when presented to the first user;
process the barcode, decode information contained in the barcode, and display the decoded information to the first user for user verification; and
transmit the decoded information to the central processing server upon user confirmation;
a second device configured to communicate with the central processing server and generate the barcode;
wherein after the decoded information from the barcode is transmitted to the central processing transferring, the central processing server transfers monetary units between the first virtual repository of monetary units and the second virtual repository of monetary units, and sends to the first user and the second user a notification of result of the transfer; and
wherein the barcode is generated for the second user and comprises encoded data of identity of the second user and security data.

11. The system of claim 10,
wherein the pairing of a first mobile communication device with the first user account comprises the first user defining a security personal identification number (PIN) to be preserved in the central processing server; and
wherein the user confirmation of the decoded information comprises the first user providing the security PIN to be transmitted by the first mobile communication device to the central processing server for authentication.

12. The system of claim 10, wherein the barcode further comprises encoded data of a payment money amount, and a base currency.

13. The system of claim 10, wherein the second device being a mobile communication device that is paired with the second user account, and is configured to display the barcode.

14. The system of claim 10, wherein the central processing server is configured to provide user interfaces that are accessible and displayable by web browser applications running in computing devices or mobile communication devices.

15. The system of claim 10, wherein the central processing server is configured to provide secure mobile payment server backend application program interfaces (APIs) enabling specially-developed applications running in computing devices or mobile communication devices to communicate with the central processing server.

16. The system of claim 14, wherein the second device being a computing device configured to run a web browser application accessing and displaying the user interfaces provided by the central processing server.

17. The system of claim 15, wherein the second device being a computing device configured to run a specially-developed application communicating with the central processing server via the secure mobile payment server backend APIs.

18. The system of claim 10, wherein the barcode being a Quick Response (QR) code.

19. A method for conducting lodging room reservation and check-in using mobile communication devices, comprising:
creating a first user account for a lodge guest user in a central processing server,
wherein the first user account creation comprises pairing a first mobile communication device with the first user account,
wherein the first mobile communication device being equipped with an optical scanner or camera and configured to communicate with the central processing server, and
wherein the first user account creation further comprises creating a first virtual repository of monetary units associating with the first user account;
creating a second user account for a lodge operator user in a central processing server,
wherein the second user account creation comprises creating a second virtual repository of monetary units associating with the second user account;
generating, by the central processing server or a second device, a barcode, wherein the second device being configured to communicate with the central processing server,
wherein the barcode being generated specifically for an assigned room reserved by the lodge guest user;
presenting the barcode to the lodge guest user at the assigned room door;
optically capturing the barcode by the first mobile communication device;
processing, by the first mobile communication device, the barcode, and decoding information contained in the barcode;
providing a first security personal identification number (PIN), by the lodge guest user, and entering the first security PIN into the first mobile communication device;
transmitting, by the first mobile communication device, the decoded information and the first security PIN to the central processing server;
authenticating and verifying, by the central processing server, the decoded information and the first security PIN; and
upon positive authentication and verification of the decoded information and the first security PIN, unlocking the assigned room door.
